(19) United States
(12) Patent Application Publication
(10) Pub. No.: US 2005/0139759 A1
(43) Pub. Date: Jun. 30, 2005

(54) Lifetime pulsed neutron/chlorine combination logging tool

(76) Inventors: Robert Pitts, Houston, TX (US); Leonard I. Casey JR., The Woodlands, TX (US); Ronald E. Bothner, The Woodlands, TX (US)

Correspondence Address: William B. Patterson;MOSER, PATTERSON & SHERIDAN, L.L.P., Suite 1500, 3040 Post Oak Blvd., Houston, TX, 77056, US

(21) Appl. No.: 10/999,818

(22) Filed: Nov. 30, 2004

Related U.S. Application Data
(63) Continuation-in-part of application No. 09/949,596, filed on Sep. 10, 2001, now Pat. No. 6,825,459.
Application No. 09/949,596 is a continuation-in-part of application No. 09/225,029, filed on Jan. 4, 1999, now abandoned.

(51) Int. Cl. G01V 5/10

(52) U.S. Cl. 250/269.6; 250/256; 250/265; 250/266; 250/269.1; 250/269.7; 376/165

(57) ABSTRACT

Methods and apparatus for logging a wellbore and determining a presence or absence of a hydrocarbon bearing formation are disclosed. A sonde includes at least two gamma radiation detectors that are utilized for chlorine logging and lifetime logging in combination. Additionally, two detectors of the sonde are spaced axially from each other at different distances from the source to enable determination and compensation for various other parameters such as porosity and water flow velocity. Appropriate gating of the detectors enables sensing total counts of radiation emitted from adjacent formations and sensing of specific energy ranges of radiation when the formation is bombarded with energy. Signals from the lifetime logging enable adjustment of the chlorine logging for a borehole effect and background radiation. The detectors can include a sheath of a high capture cross-section material that interacts with neutrons to produce gamma radiation to shield the detectors.

### CROSS-REFERENCE TO RELATED APPLICATIONS

This application is a continuation-in-part of co-pending U.S. patent application Ser. No. 09/949,596 filed Sep. 10, 2001, now U.S. Pat. No. 6,825,459, issued on Nov. 30, 2004, which is a continuation-in-part of U.S. patent application Ser. No. 09/225,029, filed on Jan. 4, 1999, which is now abandoned, which are all herein incorporated by reference.

### BACKGROUND OF THE INVENTION

1. Field of the Invention

The present invention generally relates to the field of radioactive well logging to evaluate sub-surface conditions surrounding boreholes for producing hydrocarbons, thereby determining a likelihood of oil and/or gas zones.

2. Description of the Related Art

The production of hydrocarbons from sub-surface locations typically includes the drilling of a borehole into the earth in a location where hydrocarbons are likely to be found, physically isolating the borehole from the earth surrounding it by the placement of casing therein, cementing the casing in place, and penetrating the casing at zones known or suspected to have producible quantities of hydrocarbons. This enables the hydrocarbons to flow into the casing and thence be pumped or otherwise flowed to the surface.

The location of zones likely to produce hydrocarbons is often determined by passing a tool, commonly known as a sonde, along the length of the borehole. Such sondes typically emit radiation, and in response, receive signals from the formation indicative of the geological structure adjacent to the borehole into which the radiation penetrated and the likelihood that such formations include hydrocarbons therein. Where neutrons are released from the sonde, the formation returns a signature gamma ray or gamma radiation released when a formation atom “captures” the emitted neutron.

Nuclear logging techniques may be considered to be in two classes that include thermal neutron lifetime logging (“lifetime logging”) and hydrogen and chlorine logging (“chlorine logging”). U.S. Pat. No. 3,564,248 to Hopkins, et al. describes the lifetime logging while U.S. Pat. No. 3,772,513 to Hall, et al. describes the chlorine logging. With the chlorine logging, gating a detector for discrete energy ranges enables independent sensitivity for hydrogen and chlorine when the detector is shielded by a neutron-absorbing material such as samarium. In contrast, the lifetime logging detects the total amount of neutron capture per unit time regardless of energy levels in order to determine a thermal neutron capture cross section of the formation that is based on a slope of a decay curve.

In operation, both logs provide information relating to the formation. For example, the chlorine logging enables distinguishing between the presence of salt water and hydrocarbons in the formation based on differences detected between hydrogen and chlorine in the formation. Further, the value of the thermal neutron capture cross section determined with the lifetime logging provides an indication of the chlorine content, which indicates salt water presence.

For highly accurate quantitative interpretation of the lifetime log, it is often necessary to know accurately certain parameters, such as formation porosity, fluid salinity, and shale fraction of the formation. For example, boron within shale of the formation affects the slope of the decay curve from the lifetime log. Thus, quantitative interpretation solely utilizing lifetime logging often proves unsatisfactory where certain of these parameters can only be roughly estimated. In contrast, the chlorine log when used alone requires an estimate of salinity and porosity and is subject to errors caused by variations of borehole effects or parameters, such as those resulting from washouts, poor cementation, borehole size variations and the like. However, boron within a shale formation surrounding the borehole provides a similar response as chlorine when using this chlorine log such that the shale formation appears as salt water. Accordingly, the two types of logs compliment each other in several ways when run together and benefit from more accurate porosity estimates.

Interpreting the results from the logs remains vulnerable to formation unfamiliarity since the results depend in part on a background understanding of the formations traversed by the borehole. Without such information, the results can return false positive results for the presence of hydrocarbon and false negative results which overlook the presence of hydrocarbon. Additionally, the effect of the borehole due to the presence or absence of fluids therein can affect the reliability of the data produced. Thus, the sonde may require operation in a laboratory or test borehole of known constituents and use of the test results to interpret the results obtained when used in an actual borehole.

Therefore, there exists a need for improved methods and apparatus for analyzing formations adjacent to a borehole with a minimum of calibration and a minimum of borehole effect.

### SUMMARY OF THE INVENTION

Embodiments of the invention generally relate to methods and apparatus for logging a wellbore and determining a presence or absence of a hydrocarbon bearing formation. A sonde includes at least two gamma radiation detectors that are utilized for chlorine logging and lifetime logging in combination. Additionally, two detectors of the sonde are spaced axially from each other at different distances from the source to enable determination and compensation for various other parameters such as porosity and water flow velocity. Appropriate gating of the detectors enables sensing total counts of radiation emitted from adjacent formations and sensing of specific energy ranges of radiation when the formation is bombarded with energy. Signals from the lifetime logging enable adjustment of the chlorine logging for a borehole effect and background radiation. The detectors can include a sheath of a high capture cross-section material that interacts with neutrons to produce gamma radiation to shield the detectors.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a sectional view of an embodiment of a sonde located in a borehole.

FIG. 2 is a graph of the relationship between relative intensity and gamma ray energy returned using a first pair of detectors of the sonde.

FIG. 3 is a graph of the relationship between relative count rates of gamma ray energy returned versus time using a second pair of detectors of the sonde.

FIG. 4 is a sectional view of an alternative embodiment of a sonde located in a borehole.

### DETAILED DESCRIPTION OF THE PREFERRED EMBODIMENT

Embodiments of the invention generally provide methods and apparatus for performing logging of boreholes for the detection of hydrocarbon producing zones. Generally, well logging according to embodiments of the invention includes placement of a sonde at various locations along the span of a borehole such that the sonde generates signals and receives return signals for processing in order to generate data indicative of the features of the formation surrounding the borehole.

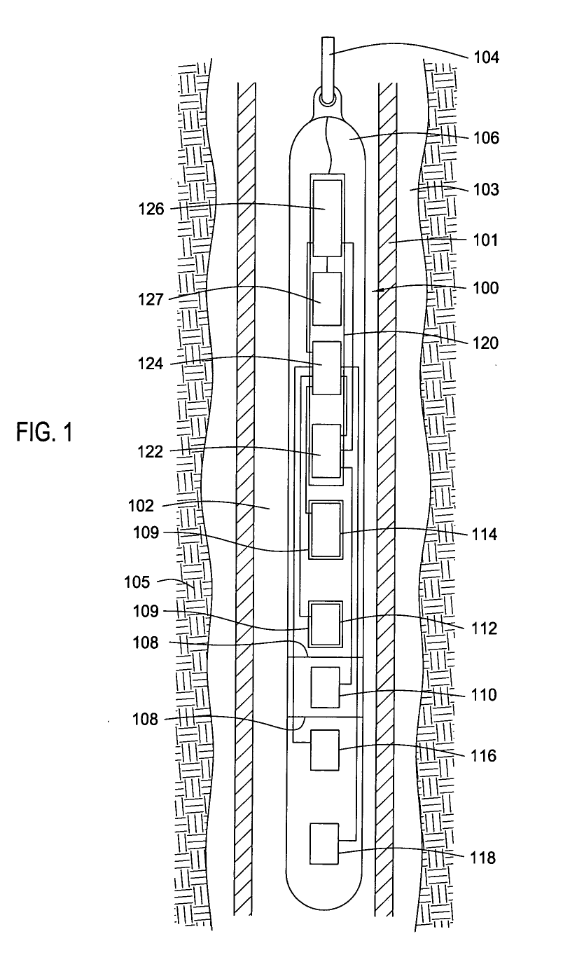

FIG. 1 illustrates a cross section of a sonde 100 suspended by a cable 104 into a borehole 102. As shown, casing 101 held in place by cement 103 isolates the borehole 102 from the formation 105 that the borehole 102 traverses. A housing 106 of the sonde 100 attaches to the cable 104 to provide a secure and waterproof environment within the interior of the sonde 100. The sonde 100 includes a neutron generator or radiation source 110, a first pair of detectors 112, 114 for chlorine logging, a second pair of detectors 116, 118 for lifetime logging, and a control section 120 all located within the housing 106. To prevent and/or reduce the effect of direct neutron bombardment of the detectors 112-118 by the neutron generator 110, the sonde 100 includes shielding 108 composed of lead, tungsten, boron or another similar element or combination thereof disposed between the neutron generator 110 and each pair of detectors. Additionally, the sonde 100 may include a centralizer device such as a leaf spring (not shown) that extends from the outer surface of the sonde 100 to cause the sonde 100 to push against the side of the borehole 102.

The control section 120 powers the neutron generator 110, manipulates and/or stores signals generated by the detectors 112-118, and may establish the position of the sonde 100 in the borehole 102. Accordingly, the control section 120 of the sonde 100 may include a power supply 122 such as a battery, a controller 124, a telemetry section 126, and a gamma ray and casing collar locator (CCL) detector 127. The controller 124 initiates powering of the neutron generator 110 in response to operator input or a depth signal. The telemetry section 126 receives the signals generated in the detectors 112-118 in response to the receipt of gamma radiation. Alternatively, the cable 104 supporting the sonde 100 may provide power to the sonde 100 and may provide a signal pathway for transmission of data from the sonde 100 to a surface location for analysis. The optional gamma ray and CCL detector 127 detects naturally occurring gamma radiation for correlation to the original depth log run in the borehole 102 and detects collars in the string of casing 101 for depth reference. Thus, the gamma ray and CCL detector 127 can send a signal indicative of depth to the telemetry section 126 for recording the depth at which the gamma radiation is recorded. For some embodiments, monitoring a length of the cable 104 lowered into the borehole 102 establishes the depth of the sonde 100 during the logging operation.

The first pair of detectors 112, 114 for the chlorine logging are located above the neutron generator 110 and spaced such that a first near detector 112 of the first pair of detectors is closer to the neutron generator 110 than a first far detector 114 of the first pair. Likewise, a second near detector 116 of the second pair of detectors for the lifetime logging is closer to the neutron generator 110 than a second far detector 118 of the second pair. Preferably, the near detectors 112, 116 of each pair are on opposed sides of the radiation source 110 and spaced an equal distance from the radiation source 110, and the far detectors 114, 118 of each pair are on opposed sides of the radiation source 110 and spaced an equal distance from the radiation source 110 that is greater than the distance between the source 110 and the near detectors 112, 114.

Each of the radiation detectors 112-118 include, for example, a scintillation detector in the form of an optically transparent thallium-activated crystal of sodium iodide or the like with an end-window photomultiplier tube optically coupled to the crystal. A suitable amplifier receives output electrical pulses generated in the photomultiplier tube and linearly amplifies such pulses. Thus, the detectors 112-118 emit signals in response to the receipt of gamma radiation. Additionally, gating circuits associated with respective ones of the detectors 112-118 receive the electrical pulses representing the detection of gamma rays and gate the detectors 112-118 such that the first pair of detectors 112, 114 for the chlorine logging are configured to be responsive to gamma radiation in specific energy ranges and the second pair of detectors 116, 118 for the lifetime logging are configured to detect the quantity of gamma radiation reaching the detectors 116, 118 during specific time periods.

A sheath 109 of preferably samarium oxide (Sm₂O₃) optionally surrounds the first pair of detectors 112, 114 for chlorine logging and can additionally surround any of the detectors disclosed herein. For this embodiment, the sheath 109 provides a samarium shield as one type of suitable material which has a characteristic neutron capture gamma radiation emission spectrum predominantly within an energy band that includes a significant part of the neutron capture gamma spectrum of certain elements (i.e., hydrogen) in the formation. The sheath 109 further includes a characteristic neutron capture gamma radiation emission spectrum substantially outside another energy band (i.e., a spectrum associated with chlorine). Accordingly, the sheath 109 enables a shale compensating effect when used for chlorine logging. While samarium is preferred as the material for the sheath 109, other materials may be employed rather than or together with samarium. For example, europium or gadolinium may also be employed as the material for the sheath 109 since these materials possess a generally similar characteristic neutron capture gamma radiation emission spectra to samarium.

As the sonde 100 lowers into the borehole 102, the power supply 122 initiates firing or operation of the neutron generator 110 upon reaching an appropriate depth. In response to the supply of power, the neutron generator 110 emits burst of neutrons in the 14 MeV (million electron volts) range that last an appropriate length of time such as approximately 60 μs (microseconds). In this manner, the neutron generator 110 generates pulses of neutrons in discrete time periods. As each burst is emitted, the neutrons travel from the generator 110, through the housing 106, the borehole constituents, if any are present, the casing 101, the cement 103 and thence into the adjacent formation 105. The neutrons interact with constituents of the materials that they pass through and generate thermal neutrons, gamma radiation and other side effects.

At each location where the neutrons emitted by the neutron generator 110 pass, a portion of the neutrons collide with atoms of the constituents of the materials and result in a slowing of the neutrons with each collision. Eventually the neutrons are captured by the nucleus of atoms with which they collide, thereby causing excited atoms to be formed. Each excited atom has a half life that depends upon the element and can last from milliseconds to a half of an hour. The excited atom decays into the original unexcited state and simultaneously emits a gamma ray or capture gamma radiation when it returns to its steady state. The energy of the gamma radiation has an energy characteristic of the atomic species that produced the gamma radiation.

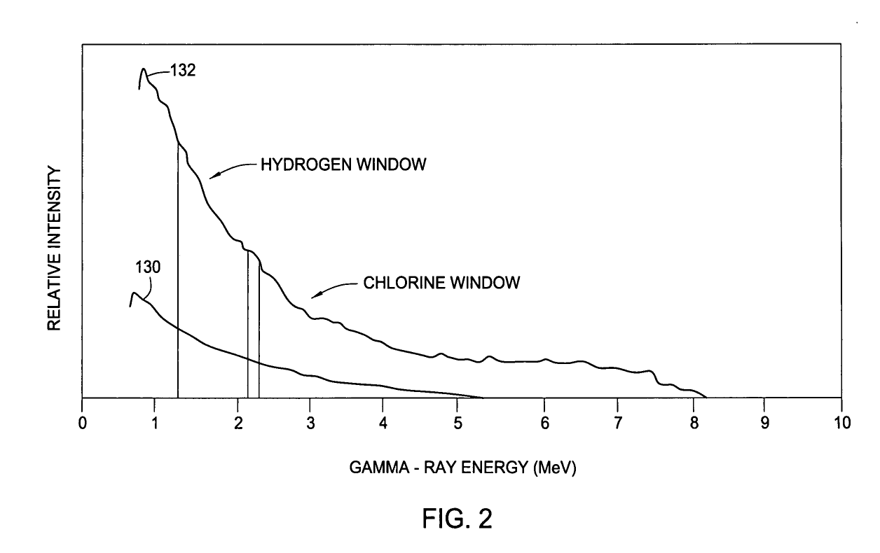

The first pair of detectors 112, 114 for the chlorine logging count radiation in the energy range of gamma radiation emitted by hydrogen and chlorine, as shown in FIG. 2. Specifically, gamma radiation emitted by the decay of hydrogen is in an energy range of about 1.2 MeV to about 2.2 MeV, whereas that indicative of decay by chlorine is in the energy range of about 2.2 MeV to about 8 MeV. The detectors 112, 114 detect gamma radiation caused by neutron capture of the constituents of the borehole 102, the casing 101, the cement 103 and the formation 105 as the sonde 100 moves in the borehole 102 and the neutron generator 110 generates the pulses of neutrons. The quantity of gamma radiation detected at the far detector 114 has a smaller amplitude or a smaller count rate than the quantity of radiation detected at the near detector 112 since a substantial quantity of the neutrons emitted by the source 110 are captured immediately adjacent to the source 110. Thus, fewer neutrons emitted by the source 110 reach a location where subsequent gamma radiation from the constituents can reach the far detector 114. FIG. 2 demonstrates the lower gamma radiation detected at the far detector 114 as shown by curve 130 that represents the counts from the far detector 114 compared to curve 132 that represents the counts from the near detector 112. Additionally, the timing of the receipt of the counts of hydrogen and chlorine gamma radiation can be recorded verses the number of counts received for further data manipulation.

Simultaneously as the first pair of detectors 112, 114 for the chlorine logging count gamma radiation in specific energy gates, the second pair of detectors 116, 118 for the lifetime logging are likewise bombarded with gamma rays resulting from the collision of neutrons emitted by the neutron generator 110 with the constituents of the borehole 102, the casing 101, the cement 103 and the formation 105. Since the second pair of detectors 116, 118 are time gated, the second pair of detectors 116, 118 count all gamma rays reaching the detectors 116, 118 during a specified time period regardless of their energy.

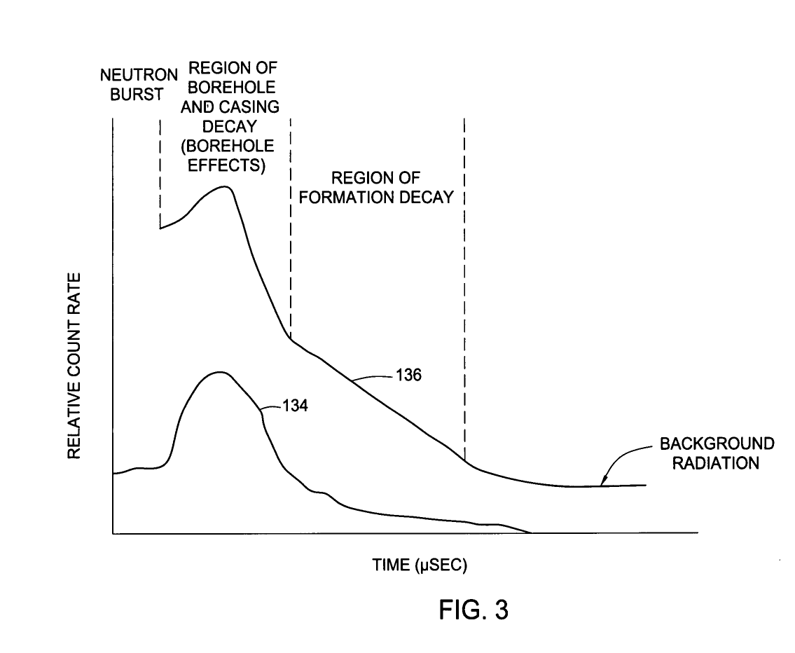

FIG. 3 shows a representative plot of total gamma radiation count versus time as detected by the detectors 116, 118 during the lifetime logging. Line 134 of the plot represents counts from the far detector 118 while line 136 represents counts from the near detector 116. During the period that the neutron source 110 emits neutrons, each detector of the second pair of detectors 116, 118 is gated closed so as to not send a signal indicative of gamma radiation detected. Following the emission of the burst of neutrons from the source, the detectors are gated open and counts of gamma radiation received at the detectors 116, 118 are generated and sent for recording in a time verses counts manner. As seen in FIG. 3, the initial count rate of gamma radiation detected by the detectors increases and then falls off into a decay mode. As labeled in FIG. 3, the initial portion of the detected gamma radiation is indicative of the interaction of the emitted neutrons with the constituents of the borehole 102 and the casing 101. Thereafter, the count rate versus time relationship shows a decay relationship where the number of counts decreases over time as the total quantity of neutrons emitted by the source are captured by the formation and are no longer available to subsequently create gamma radiation.

As labeled in FIG. 3, the second pair of detectors 116, 118 detect residual background radiation of the borehole 102 and the formation 105 during a background interval portion of each operating cycle defined by a background circuit subsequent to the measurement portion of the cycle. The residual background radiation provides a compensating factor during the derivation of both the thermal neutron capture cross section for the lifetime logging and the determination of the relative presence of hydrogen and chlorine in the formation for the chlorine logging.

Using the data returned by both pairs of detectors 112-118 enables determination of a delay period after which the counting of hydrogen and chlorine counts provided by the first pair of detectors 112, 114 is cumulated. The hydrogen and chlorine counts obtained by the first pair of detectors 112, 114 may be selected in time from the region of formation decay illustrated in FIG. 3 using the results of the time gated analysis provided by the second pair of detectors 116, 118. Thus, the first set of detectors 112, 114 may be time gated in addition to being energy gated. This eliminates or substantially reduces any localized borehole 102, casing 101 and/or cement 103 effect (the borehole effect) upon the data returned from the first pair of detectors 112, 114 during the chlorine logging.

A ratio of radiation counts detected between the first near detector 112 and the first far detector 116 indicates the porosity and formation matrix of the formation 105. Alternatively or in combination, a ratio of radiation counts detected between the second near detector 116 and the second far detector 118 also indicates the porosity of the formation 105. Thus, either pair of the detectors 112-118 for either chlorine logging or lifetime logging can measure porosity of the formation 105. Preferably, the porosity measurement is not split between different pairs of the detectors 112-118. The basis for these porosity measurements derives from the fact that where the porosity is high, the hydrogen filling the pore space captures the neutron quickly and close to the source 110 such that measurements at the near detectors 112, 116 are high. In contrast, a lower porosity enables the neutrons to diffuse further into the formation 105 and hence increase the measurements at the far detectors 114, 118 due to the fact that the pore space therein limits the hydrogen in close proximity to the source 110 for capturing the neutrons. Advantageously for the porosity measurements, hydrogen located within the pore space of the formation 105 does not depend on whether oil or water is present in the formation 105.

The sonde 100 may also be used to track a water flow velocity in or behind the casing 101 by using one or more of the detectors 112-118 and gating them to detect gamma radiation at a specific gamma radiation energy emitted by oxygen as the result of capture of a thermalized neutron by the oxygen. Specifically, the detectors 112-118 detect energy at all energy levels and configuration of detection circuitry for tracking the velocity of water flow gates the signal from selected ones of the detectors 112-118 to discriminate energy detected in certain ranges or specific energies associated with the gamma radiation energy released by oxygen atoms after capture of the thermal neutrons. This information enables flow rate within the borehole 102 to be determined if it can be established or known that the flow is inside the casing 101.

In an operation to detect the water flow velocity, the source 110 emits a burst of high energy neutrons from the sonde 100 that can be stationary in the borehole 102. Subsequent pulses from the source 110 can be slowed down or shut off for a period of time while measurements are made in order to determine the water flow velocity. Frequency of the pulses can be changed from the surface via the cable 104. If the sonde 100 is moving in the borehole 102, this movement must be compensated for in determining the water flow velocity. As discussed previously, the neutrons emitted by the source 110 travel into the borehole 102, casing 101, cement 103 and formation 105. The neutrons emitted by the source 110 subsequently result in the emission of about a 6.13 MeV gamma ray if thermalized and captured by an oxygen atom, which indicates water presence. Since the half-life of the excited oxygen atom is approximately 7.35 seconds, the moving water molecule that releases the gamma ray will likely have moved between the time of capture proximate the source 110 and the time of release of the gamma ray.

Accordingly, the gamma radiation emits from a different location with respect to the location where the neutron was emitted from the source 110. One or both detectors of the first pair of detectors 112, 114 sense the upward flow of water while one or both detectors of the second pair of detectors 116, 118 identify the downward flow of water. Monitoring which ones of the detectors 112-118 receives the majority of the gamma radiation provides an indication of the water flow direction that can be horizontal and/or upwards or downwards. The water moving in a direction away from one of the detectors 112-118, either vertically and/or horizontally, causes an observed decrease in activity due to an expected exponential decay characteristic plus an additional decrease caused by the induced radioactivity in the water being swept away from the vicinity of the detector by the movement thereof. The observed decrease in the induced activity above the expected exponential decay characteristic can then be used to determine the velocity of the moving water. For detecting horizontal flow, a directional shield may be used.

Further, every slug of activated flowing water generates an increase of counts as it gets closer and closer to one of the detectors 112-118 and causes a decrease of counts as it moves away from the detector. After a time dependent upon the spacing of the source 110 and the detectors 112-118 and the flow velocity, the slug of water does not contribute anymore to the counts. Thus, the total counts curve comprises a characteristic peak representative of the flow and an exponential decay curve representative of stationary oxygen. This peak includes information about the flowing oxygen and thence about the water flow velocity. The peak detected with a single one of the detectors 112-118 indicates velocity based on the distance between the source 110 and the detector and the time between activation and detection of the peak. Where the peak is detected with one of the pairs of detectors, the peak appears in time at a respective one of the near detectors 112, 116 depending on the direction of water flow before the peak is detected with the respective one of the far detectors 114, 118 since the slug passes by the near detector before the far detector. Accordingly, the distance between the near and far detectors and the time difference between respective peaks sensed with the near and far detectors enables calculation of the water flow velocity.

The sonde 100 having two pairs of detectors 112-118 can be used to determine formation parameters such as porosity and formation matrix and water flow direction and velocity. By combining the capabilities of the chlorine logging with the lifetime logging, the invention enables locating likely reserves of hydrocarbons adjacent to boreholes without the need for complex calibration paradigms and without the need to know the likely porosity, resistivity, etc. of the formations before using the sonde 100 or evaluating the results. Further, the data from the lifetime logging can be used in accurately eliminating or reducing the borehole effect during the chlorine logging.

Although a specific embodiment of the sonde 100 for logging has been disclosed with reference to FIG. 1, departures therefrom are well within the scope of one skilled in the art. As apparent from this disclosure, some embodiments can utilize a single detector for the chlorine logging and a single detector for the lifetime logging, which are each spaced different distances from the source 110. For other embodiments, the sonde 100 can utilize a single detector for either the chlorine logging and a pair of detectors for the lifetime logging or a pair of detectors for the chlorine logging and a single detector for the lifetime logging. According to yet other embodiments, a single set of detectors (e.g., the detectors 112, 114) spaced from the source can be gated for both the chlorine logging and the lifetime logging to combine functions of the detectors 112, 114 with the detectors 116, 118. Additionally, U.S. Pat. No. 6,825,459, which is herein incorporated by reference in its entirety, describes applications utilizing near and far detectors during chlorine logging that can be implemented when both the near and far detectors 112, 114 for chlorine logging are utilized.

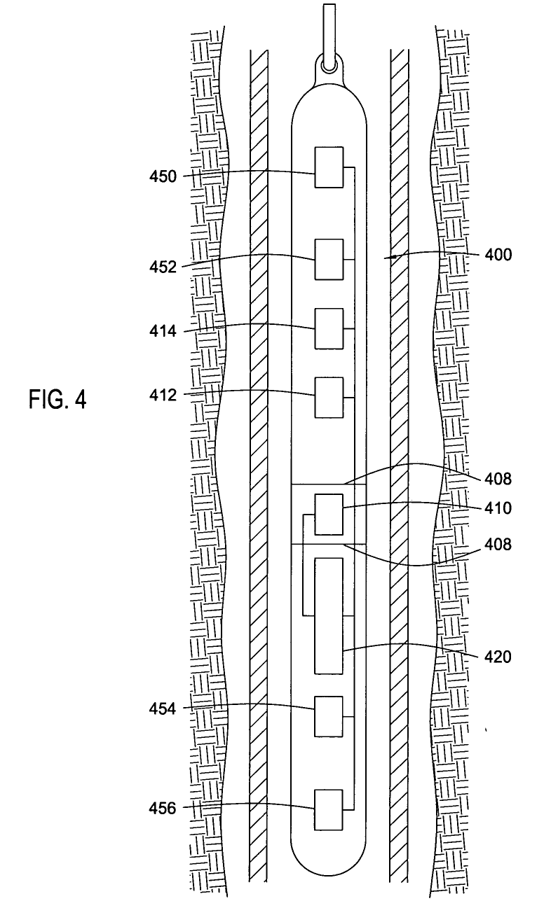

As an example, FIG. 4 illustrates another embodiment of a sonde 400 utilizing an alternate arrangement of detectors to perform the lifetime logging, the chlorine logging, the porosity and formation matrix determinations and the water flow determinations as discussed above. Similar to the sonde 100 shown in FIG. 1, the sonde 400 includes a neutron generator or radiation source 410, shielding 408 and a control section 420. A single set of chlorine and lifetime logging detectors 412, 414 are spaced from the source 410 at near and far distances, which can be approximately eighteen and twenty-three inches, respectively. The detectors 412, 414 are each gated for both the chlorine logging and the lifetime logging and can be used together for the porosity and formation matrix determinations. Preferably, the chlorine and lifetime logging detectors 412, 414 are disposed on an opposite side of the source 410 from the control section 420 due to spacing requirements for the control section 420.

The sonde 400 additionally includes a first pair of water flow detectors 450, 452 located above the source 410 and an optional second pair of water flow detectors 454, 456 located below the source 410 and the control section 420. Near water flow detectors 452, 454 are preferably spaced approximately twenty-three inches from the source 410 while far water flow detectors 450, 456 are preferably spaced about forty-two inches from the source 410. Due to their close proximity to one another, the near water flow detector 452 can be combined with the far chlorine and lifetime logging detector 414 by incorporating the appropriate gating in a single combined detector.

Similar to the detection of water flow as described above, the first pair of water flow detectors 450, 452 detect water flowing past the source 410 in a direction toward the first pair of water flow detectors 450, 452 while the second pair of water flow detectors 454, 456 detect water flowing past the source 410 toward the second pair of water flow detectors 454, 456. In other operations to detect water flow, the source 410 emits a burst of high energy neutrons from the sonde 400 at a first location and the sonde 400 is then moved a distance such that the first pair of water flow detectors 450, 452 are positioned below the first location by a predetermined amount prior to taking measurements. In this manner, the far water flow detector 450 measures a near distance from the first location where the source 410 emitted and the near water flow detector 452 measures a far distance from the first location in order to detect water flowing past the source 410 away from the first pair of detectors 450, 452.

While the foregoing is directed to embodiments of the invention, other and further embodiments of the invention may be devised without departing from the basic scope thereof, and the scope thereof is determined by the claims that follow.

1. A tool for logging a formation adjacent to a borehole, comprising:
a pulsed neutron radiation source for irradiating the formation;
at least one first detector configured to detect a first signal indicative of an interaction of radiation emitted from the radiation source with constituents of the formation;
at least one second detector configured to detect a second signal indicative of an interaction of radiation emitted from the radiation source with constituents of the formation, wherein the first and second detectors are axially spaced apart along a length of the tool at different distances from the source such that the first and second signals are indicative of at least a first and a second distance from the source, respectively; and
a controller operable to select specific portions of the first and second signals for evaluation thereof, wherein the controller selects portions of at least one of the signals indicative of specific ranges of energies of radiation and selects a portion of at least one of the signals indicative of a total quantity of radiation as a function of time.

2. The tool of claim 1, wherein at least one of the detectors includes a shield.

3. The tool of claim 1, wherein at least one of the detectors includes a shield comprising samarium.

4. The tool of claim 1, wherein the specific ranges of energies include separate ranges of about 1.2 MeV to about 2.2 MeV and about 2.2 MeV to about 8.0 MeV, which are indicative of hydrogen and chlorine, respectively.

5. The tool of claim 1, wherein the specific ranges of energies include separate ranges of about 1.2 MeV to about 2.2 MeV, about 6.13 MeV, and about 2.2 MeV to about 8.0 MeV, which are indicative of hydrogen, water and chlorine, respectively.

6. The tool of claim 1, further comprising at least one third detector configured to detect a third signal indicative of an interaction of radiation emitted from the radiation source with constituents of the formation for use in detecting water flow, the third detector axially spaced from the source further than the at least one first and second detectors.

7. The tool of claim 1, wherein the at least one first detector includes two detectors disposed on opposite sides of the source from one another, and the at least one second detector includes two detectors disposed on opposite sides of the source from one another.

8. A method of logging a formation adjacent to a borehole, comprising:
emitting a pulse of neutrons from a radiation source;
providing at least two gamma radiation detectors for sensing radiation emitted from constituents of the formation after being irradiated with the pulse of neutrons;
detecting specific energy signals representative of an energy of radiation received with at least one of the at least two gamma radiation detectors, the specific energy signals for use in chlorine logging;
detecting total count signals indicative of a total amount of radiation received with at least one of the at least two gamma radiation detectors as a function of time, the total count signals for use in lifetime logging; and
detecting a ratio of radiation between first and second detectors of the at least two gamma radiation detectors in order to determine a porosity of the formation, the first and second detectors axially spaced apart at different distances from the radiation source.

9. The method of claim 8, further comprising determining a presence and flow direction of water.

10. The method of claim 8, further comprising determining a water flow velocity.

11. The method of claim 8, further comprising determining a water flow rate.

12. The method of claim 8, further comprising shielding at least one of the at least two gamma radiation detectors during operation with a material having a characteristic neutron capture gamma radiation emission spectrum predominantly within an energy band that includes a significant part of the neutron capture gamma spectrum of hydrogen.

13. The method of claim 8, further comprising:
determining a borehole effect from the total count signals; and
adjusting the specific energy signals for the borehole effect.

14. The method of claim 8, further comprising:
determining a background radiation from the total count signals; and
adjusting the specific energy signals for the background radiation.

15. The method of claim 8, wherein the specific energy signals are indicative of gamma radiation released from previously excited hydrogen and chlorine atoms.

16. A method of logging a formation adjacent to a borehole, comprising:
emitting a pulse of neutrons from a radiation source;
providing at least two gamma radiation detectors for sensing radiation emitted from constituents of the formation after being irradiated with the pulse of neutrons;
detecting radiation indicative of oxygen by first and second detectors of the at least two gamma radiation detectors in order to determine a presence and flow direction of water, wherein the first and second detectors are axially spaced apart at different distances from the radiation source;
detecting specific energy signals representative of an energy of radiation received with at least one of the at least two gamma radiation detectors, the specific energy signals for chlorine logging; and
detecting total count signals indicative of a total amount of radiation received with at least one of the detectors as a function of time, the total count signals for lifetime logging.

17. The method of claim 16, further comprising determining a water flow velocity.

18. The method of claim 16, further comprising determining a water flow rate.

19. The method of claim 16, further comprising shielding at least one of the at least two gamma radiation detectors during operation with a material comprising samarium.

20. The method of claim 16, further comprising:
determining a borehole effect from the total count signals; and
adjusting the specific energy signals for the borehole effect.
